(19) United States
(12) Patent Application Publication
(10) Pub. No.: US 2010/0056157 A1
(43) Pub. Date: Mar. 4, 2010

(54) Method and Apparatus for Making Handover Decisions in a Heterogeneous Network

(75) Inventors: Itzhak Verona, Carlsbad, CA (US); Matthew D. Fitzpatrick, Poway, CA (US); Steve L. Sheya, Vernon Hills, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/198,352

(22) Filed: Aug. 26, 2008

(51) Int. Cl. H04Q 7/20

(52) U.S. Cl. 455/438

(57) ABSTRACT

A method and apparatus for handover of a mobile station from a serving system to a target system, where a network of the serving system is different from a network of the target system is disclosed. The method includes measuring a Link Quality (LQ) of the target system and adjusting a nominal handoff threshold based on the Link Quality measurement to produce an adjusted handoff threshold. The method further includes, determining whether a handoff of the mobile station from the serving system to the target system should occur, based on the adjusted handoff threshold.

### FIELD OF THE DISCLOSURE

The present disclosure relates generally to the field of heterogeneous networks and more particularly to making handover decisions in a heterogeneous network.

### BACKGROUND

Wireless cellular communication mobile stations with multi-service interoperability have become increasingly prevalent in recent years. Such multi-service mobile stations enable communication in areas served by multiple radio access technologies (RATs), for example, CDMA and IEEE 802.11b. It is desirable for a wireless network user to be able to take advantage of the best features of each RAT using a multi-service mobile station. For example, a user may desire a CDMA wireless network's wide service area and also an IEEE 802.11b wireless network's high bandwidth. It is also known that signal strengths in different RATs are not directly comparable. A level of signal strength that provides a good quality of service in one wireless network may result in a poor quality of service in another.

One of the problems in wireless network designing is deciding when a mobile device should handoff (sometimes called “handover”) communications from one base station to another base station. The problem becomes complicated when the base stations use different RATs. Several techniques exist to decide handoff of a mobile station. One such technique is to handoff the mobile station from a serving system to an available target system based on the serving system's Quality of Service (QoS), e.g., signal strength, packet error rate, packet loss rate, etc. However, relying solely on the QoS of the serving system may result in handoff of the mobile station to a target system that provides inferior service because one RAT's QoS measurements may not be directly comparable to another RAT's QoS measurements.

Accordingly, there is a need for a method and an apparatus for making handover decisions in heterogeneous networks.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram illustrating a heterogeneous wireless communication system in accordance with some embodiments.

FIG. 2 is a schematic illustrating dynamic thresholds of the heterogeneous wireless communication system of FIG. 1 in accordance with an embodiment.

FIG. 3 is a schematic illustrating dynamic thresholds of the heterogeneous wireless communication system of FIG. 1 in accordance with another embodiment.

FIG. 4 is a schematic illustrating dynamic thresholds of the heterogeneous wireless communication system of FIG. 1 in accordance with another embodiment.

FIG. 5 is a schematic illustrating dynamic thresholds of the heterogeneous wireless communication system of FIG. 1 in accordance with another embodiment.

FIG. 6 is a flowchart of a method for handover of a mobile station from a serving system to a target system in accordance with some embodiments.

FIG. 7 is a block diagram of a mobile station in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Various embodiments of the invention provide a method for handover of a mobile station from a serving system to a target system, where a radio access technology (RAT) of the serving system is different from a RAT of the target system. The method includes measuring a Link Quality (LQ) of the target system and adjusting a nominal handoff threshold based on the Link Quality measurement to produce an adjusted handoff threshold. The method further includes, determining whether a handoff of the mobile station from the serving system to the target system should occur, based on the adjusted handoff threshold.

Before describing in detail the method for handover of a mobile station from a serving system to a target system, it should be observed that the present invention resides primarily in combinations of method steps and apparatus components related to handover of a mobile station from the serving system to the target system. Accordingly, the method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

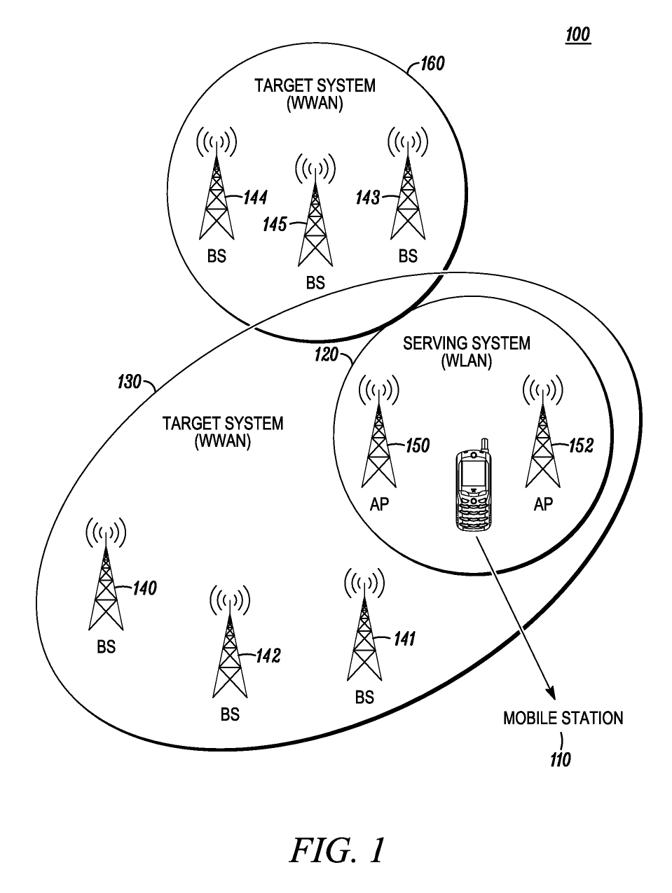

FIG. 1 is a block diagram illustrating a heterogeneous wireless communication system 100 where various embodiments of the present invention may be practiced. The heterogeneous wireless communication system 100 includes a coverage area of a serving system 120 and coverage area of one or more target systems 130, 160. Although two potential target systems are shown, any number (zero and higher) of potential target systems can be accommodated. The coverage area of the serving system 120 is divided into a plurality of cells (not shown) served by access points (AP) 150, 152. Similarly, each coverage area of the target system 130, 160 is divided into a plurality of cells (not shown) served by base stations (BS) 140, 141, 142, 143, 144, and 145. A mobile station 110 in the serving system 120 is served by one of the access points 150, 152. Examples of the mobile station 110 (sometimes called “user equipment”) include a radiotelephone, laptop or other personal or portable computer, a personal digital assistant with wireless communication capabilities, or similarly equipped electronic devices having the ability to send and/or receive wireless communication information.

The serving system 120 uses a different radio access technology than the target system 130. For example, the network of the serving system 120 is a Wireless Local Area Network (WLAN) and the network of the target system 130 is a Wireless Wide Area Network (WWAN). The WLAN network uses, for example, IEEE 802.11b as its radio access technology. Alternate RATs for a WLAN include IEEE 802.11a, IEEE 802.11g, and mesh networks. Also, even though we use the term WLAN, a wireless personal area network (WPAN) such as Bluetooth or HomeRF may be substituted under certain circumstances, and a wireless metropolitan area network (WMAN) such as WiMAX using IEEE 802.16 or IEEE 802.20 may be substituted in other circumstances.

Examples of WWANs are cellular networks using RATs such as Code Division Multiple Access (CDMA), Global System for Mobile communications (GSM), General Packet Radio Service (GPRS), and Cellular Digital Packet Data (CDPD). Each AP 150, 152 in the serving system 120 provides WLAN service to mobile stations 110 within its coverage area using wireless signals and protocols for the WLAN. For illustrative purposes, each coverage area of the serving system 120 and the target system 130, 160 is shown in circular shape although the actual shape of the coverage area will vary based on signal interference from external sources. As the mobile station 110 moves geographically across the heterogeneous wireless communication system 100 away from an access point 150 of a serving system 120 towards a base station point 141 of a target system 130 or when the mobile station 110 stays in the serving system 120, the QoS offered by the serving system is periodically measured. Based on the measured QoS, the mobile station 110 in the serving system 120 can handoff communication to one of the base stations e.g., 141 of the target system 130. In an embodiment, the serving system and the target system refer to different types of services. In this embodiment, the mobile station connects to multiple heterogeneous systems simultaneously but receives service from only one at a time (e.g. voice call, streaming video, etc). The handoff in this context would apply to a specific service provided, so that the service would be uninterrupted even though the serving system changes from one RAT to another RAT.

In general, a mobile station 110 initiates the handover of communication from the serving system 120 to the target system 130 based on determining that the signal strength of the service offered by the serving system 120 crosses a predetermined (nominal) handoff threshold. Accordingly, in an embodiment, the mobile station 110 initiates or delays handover by adjusting the nominal handoff threshold for the serving system. Handoff occurs when the signal strength of the serving system crosses the adjusted handoff threshold.

In an embodiment, the nominal handoff threshold is adjusted based on measuring a Link Quality of the target system 130 or 160. The Link Quality is measured for the most preferred target system 130 or 160 at the time of measurement. As an example, the Link Quality of target CDMA system is measured by determining a ratio of energy per chip to interference power spectral density (Ec/Io) of the target system. The measured Link Quality of the target system is categorized into one of a plurality of Link Quality bands, as shown in an example under Function Table 1.

FUNCTION TABLE 1

| (Target System) | Ec/Io (dB) of Target | |
|---|---|---|
| Link Quality Bands | System | Primary LQ Factor (dB) |
| Good | >−7 | 0 |
| Fair | −7 to −11 | −1 |
| Poor | −11 to −14 | −3 |
| No Service | <−14 | −10 |

The Link Quality measurement is categorized to be in a “good” Link Quality band, when an Ec/Io measurement is greater than a first threshold e.g., >−7 dB. The Link Quality measurement is categorized to be in an “no service” Link Quality band, when an Ec/Io measurement is less than a second threshold e.g., <−14 dB. The Link Quality measurement is categorized to be in a “fair” Link Quality band, when an Ec/Io measurement is less than the first threshold and greater than a third threshold, e.g., −7 to −11 dB. The Link Quality measurement is categorized to be in a “poor” Link Quality band, when an Ec/Io measurement is less than the third threshold and greater than the second threshold, e.g., −11 to −14 dB. Additional thresholds can be provided to enable further granularity for bands of Link Quality.

In an embodiment, the nominal handoff threshold is then adjusted by a factor called a Link Quality factor. The Link Quality factor is calculated for each Link Quality band based on a pre-defined function. The pre-defined function depends on the Link Quality measurement of each Link Quality band as shown in the Function Table. In an example, the pre-defined function is determined based on higher granularity equations involving Link Quality measurements of the target system. In another example, the pre-defined function is determined based on a direct mapping of Link Quality measurements of the target system to a range of handoff thresholds. In another example, the pre-defined function is determined based on predictive changes. The predictive changes are based on a history of Link Quality measurements. Such historical data may include an identification of the serving system and the identification of the most likely target system for handoff, a history of handoffs, and information related to past Link Quality measurements of a target system, collected during previous operation of the mobile station.

Based on the calculated Link Quality factor, the mobile station adjusts the nominal handoff threshold for the serving system by either increasing or decreasing the nominal handoff threshold. In an example, the nominal handoff threshold is expressed as a Signal-to-Noise Ratio (SNR) in decibels (dB). The mobile station either increases the nominal handoff threshold for the serving system or keeps the nominal handoff threshold for the serving system unaltered, when the Link Quality measurement of the target system is above a predetermined Link Quality threshold. Conceptually, increasing the nominal handoff threshold for the serving system contracts the geographic coverage area (“footprint”) of the serving system, thereby resulting in a quicker handoff from the serving system to the target system.

Conversely, the nominal handoff threshold for the serving system is decreased when the Link Quality measurement of the target system is below a predetermined Link Quality threshold. Conceptually, decreasing the nominal handoff threshold for the serving system expands the footprint of the serving system, thereby resulting in a delayed handoff from the serving system to the target system. In other words, the mobile station stays in the serving system until the signal strength of the serving system becomes weaker and crosses the adjusted (decreased) handoff threshold.

The adjusted handoff threshold is determined as,

AdjTh=NmTh+f(Tg LQ Band) equation (1)

Where,

AdjTh is the adjusted threshold,

NmTh is the nominal threshold, and

F (Tg LQ Band) is the Link Quality factor as a function of defined LQ bands.

In another embodiment, in addition to (or instead of) adjusting the nominal handoff threshold for the serving system, the mobile station adjusts the nominal handoff threshold for the target system. For example, the signal strength of the serving system becomes weak and a link quality measurement of the target system indicates a “good” CDMA target system is available based on Ec/Io measurements. The mobile station initiates a handoff from the serving system to the target system by adjusting the nominal handoff threshold for the serving system by a Link Quality factor as shown in Function Table 1. However, after registering with the target system for handoff (and prior to handoff), an error rate of the target system is measured. In an example, the error rate refers to a paging channel cyclic redundancy check (CRC) failure rate of the CDMA target system. If the measured error rate of the CDMA target system indicates a high CDMA loading, the nominal handoff threshold is adjusted for the target system by a secondary Link Quality Factor as shown in Function Table 2. Adjusting the nominal threshold for the target system delays actual handoff to the target system in case the measured error rate of the target system is high.

For example, the network of the serving system is a Wireless Local Area Network (WLAN), e.g., WiFi, and the network of the target system is a Wireless Wide Area Network (WWAN), e.g., CDMA. The error rate is measured for the most preferred target system at the time of measurement. The measured Link Quality of the target system is categorized into one of a plurality of secondary Link Quality bands, as shown in an example under Function Table 2.

FUNCTION TABLE 2

| (Target System) | | |
|---|---|---|
| Secondary Link Quality | LQ (paging channel CRC | Secondary LQ |
| Bands | failure) of Target System | Factor (dB) |
| Good | 0% | 2 |
| Fair | 1% | −4 |
| Poor | 2% | −8 |
| No Service | >2% | −12 |

The Link Quality measurement is categorized to be in a “good” secondary Link Quality band, when a paging channel CRC failure rate measurement is 0% for example. The Link Quality measurement is categorized to be in a “no service” secondary Link Quality band, when a paging channel CRC failure rate measurement is greater than 2%, for example. The Link Quality measurement is categorized to be in a “fair” secondary Link Quality band, when a paging channel CRC failure rate measurement is 1% for example. The Link Quality measurement is categorized to be in a “poor” secondary Link Quality band, when a paging channel CRC failure rate measurement is 2% for example. Additional thresholds can be provided to enable further granularity for bands of secondary Link Quality.

In an embodiment, the nominal handoff threshold is then adjusted by a factor called a secondary Link Quality factor. The secondary Link Quality factor is calculated for each secondary Link Quality band based on a pre-defined function. The pre-defined function depends on the Link Quality measurement of each secondary Link Quality band as shown in the Function Table 2. Based on the calculated secondary Link Quality factor, the nominal handoff threshold for the target system is adjusted by either increasing or decreasing the nominal handoff threshold for the target system. Generally speaking, this secondary Link Quality factor is an adjustment to a previous primary Link Quality factor adjustment.

The nominal handoff threshold for the target system is increased when the Link Quality measurement of the target system is below a predetermined Link Quality threshold. Increasing the nominal handoff threshold for the target system contracts the geographic coverage area (“footprint”) of the target system, thereby resulting in a delayed handoff from the serving system to the target system. In other words, the mobile station stays in the serving system till the error rate of the target system becomes better. Similarly, the nominal handoff threshold for the target system is decreased when the Link Quality measurement of the target system is above a predetermined Link Quality threshold. Decreasing the nominal handoff threshold for the target system expands the footprint of the target system, thereby resulting in a quicker handoff from the serving system to the target system. On determining that the signal strength of the service offered by the target system crosses the adjusted handoff threshold for the target system, handoff is initiated from the serving system to the target system.

In an example, when the Link Quality measurement of the CDMA service indicates “good” CDMA, then according to Function Table 1, the nominal threshold is adjusted by a LQ factor of 0 dB i.e., the nominal threshold remains unaltered. A handoff from the serving system is initiated when the signal strength of the serving system goes below the adjusted handoff threshold of say 20 dB (which in this case is the same as the nominal threshold). After registering with the target system for handoff, an error rate of the target system is measured. If the measured error rate indicates a high failure rate say 2%, then the nominal handoff threshold is adjusted for the target system by a LQ factor of −8 dB according to Function Table 2. The adjusted nominal threshold for the target system is now 20 dB−8 dB =12 dB. Thus, a handoff from the serving system to the target system is delayed to occur at 12 dB instead of 20 dB. Adjusting the nominal threshold based on the target system's error rate in addition to adjusting the nominal threshold based on the Target system's Link Quality ensures that communication is not handed off to a target system that has high error rate.

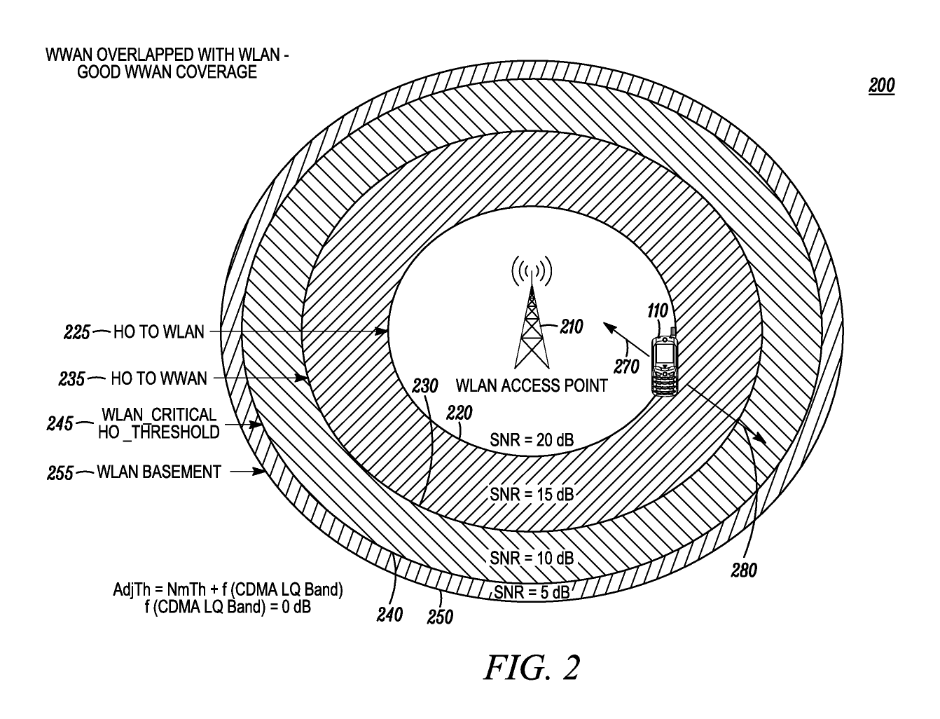

FIG. 2 is a schematic 200 illustrating dynamic thresholds of the heterogeneous wireless communication system of FIG. 1 in accordance with an embodiment. The heterogeneous wireless communication system includes a WLAN, e.g., an Access Point 210 using 802.11b as its RAT. The communication system further includes a WWAN, e.g., a CDMA base station (not shown) having overlapped coverage with the Access Point 210. This is similar to the situation of AP 150 shown in FIG. 1. In this example, a measured Link Quality of the CDMA service indicates good CDMA coverage (i.e. the Link Quality is in the “good” Link Quality band). In this example, WiFi is the serving system for a mobile station 110 and CDMA is the target system for the mobile station. The circular bands around the Access Point 210 represent handoff thresholds expressed as SNR in dB for the WiFi service. In the example as shown, the 20 dB SNR represents a first nominal handoff threshold 225 for a CDMA to WiFi handoff. The 15 dB SNR represents a second nominal handoff threshold 235 for a WiFi to CDMA handoff. The 10 dB SNR represents a critical handoff threshold 245 for handoff from WiFi to CDMA. In an example, where there is an interruption in the WiFi service and the signal strength of the WiFi service abruptly crosses 10 dB SNR, then a handoff to CDMA is immediately effected. The threshold of 5 dB SNR represents a WiFi basement 255 beyond which there is no WiFi coverage.

In an example, the mobile station 110 is moving towards 270 the WiFi access point 210 (target system) and the Link Quality measurement of the CDMA service (serving system) indicates good CDMA coverage. For a Link Quality factor of say “0 dB” for a “Good” LQ band, the adjusted handoff threshold value 220 for the first nominal handoff threshold 225 is as follows, according to (1),

Adjusted first handoff threshold=20 dB+0 dB=20 dB.

As shown in FIG. 2, the adjusted first handoff threshold value 220 is the same as the first nominal handoff threshold 225. Conceptually, the coverage area of the WLAN access point 210 is unaltered. In this scenario, the mobile station stays in good CDMA coverage rather than handing off to WiFi coverage at an earlier opportunity. A handoff to the WiFi service thus occurs only when the signal strength of the WiFi service crosses the adjusted first handoff threshold value 220 of 20 dB SNR.

In another example, instead of a 0 dB LQ factor, using a 1 dB LQ factor for a “Good” LQ band would result in,

Adjusted first handoff threshold=20 dB+1 dB=21 dB.

In this example, the first nominal handoff threshold 225 is increased such that WiFi footprint contracts and the handoff of the mobile station to the WiFi service is delayed. In other words, the mobile station stays in good CDMA coverage longer rather than handing off to WiFi coverage sooner. A handoff to the WiFi service would usually occur when the signal strength of the WiFi service crosses the first nominal handoff threshold 225 of 20 dB SNR. However, since the CDMA service offers good coverage, the first nominal handoff threshold 225 is dynamically adjusted to effect a delay in handoff of the mobile station to WiFi service. In other words, handoff to WiFi service occurs only after the signal strength of WiFi service increases to cross the adjusted first handoff threshold of 21 dB instead of the first nominal handoff threshold 225 of 20 dB SNR.

In another example as shown in FIG. 2, the mobile station 110 moves away 280 from the WiFi access point 210 (serving system) and the Link Quality measurement of the CDMA service (target system) indicates good CDMA coverage. A handoff would usually occur when the signal strength of the WiFi service crosses the second nominal handoff threshold 235 of 15 dB SNR. However, in this scenario, since the CDMA service offers good coverage, the second nominal handoff threshold 235 is dynamically adjusted to effect a quick handoff the mobile station to CDMA service. For a Link Quality factor of say “0 dB” for a “good” LQ band, the adjusted handoff threshold value 230 for the second nominal handoff threshold 235 is as follows,

Adjusted second handoff threshold=15 dB+0 dB=15 dB.

Conceptually, the adjusted second handoff threshold value 230 is the same as the second nominal handoff threshold 235. Conceptually, the coverage area of the WiFi access point 210 is unaltered. In other words, handoff from WiFi service to CDMA service occurs when the signal strength of WiFi service crosses the adjusted second handoff threshold value 230 of 15 dB SNR.

In another example, for a Link Quality factor of say “1 dB” for a “good” LQ band, the adjusted handoff threshold value for the second nominal handoff threshold 235 is as follows,

Adjusted second handoff threshold=15 dB+1 dB=16 dB.

Conceptually, the second nominal handoff threshold 235 is increased such that the WiFi footprint contracts. In other words, handoff from WiFi service to CDMA service occurs sooner when the signal strength of WiFi service crosses the adjusted second handoff threshold value of 16 dB SNR instead of waiting for the signal strength to weaken further and cross the second nominal handoff threshold of 15 dB SNR.

The critical handoff threshold 245 is also adjusted by the LQ factor. The adjusted critical handoff threshold value 240 is then used for critical handoff from WiFi to CDMA. For a Link Quality factor of say “0 dB” for a “good” LQ band, the adjusted critical handoff threshold value 240 is as follows,

Adjusted critical handoff threshold=10 dB+0 dB=10 dB.

A handoff from WiFi service to CDMA service occurs when the signal strength of WiFi service is at the adjusted critical handoff threshold of 10 dB SNR. The WiFi basement value 250 of 5 dB SNR as shown in figure remains unaltered.

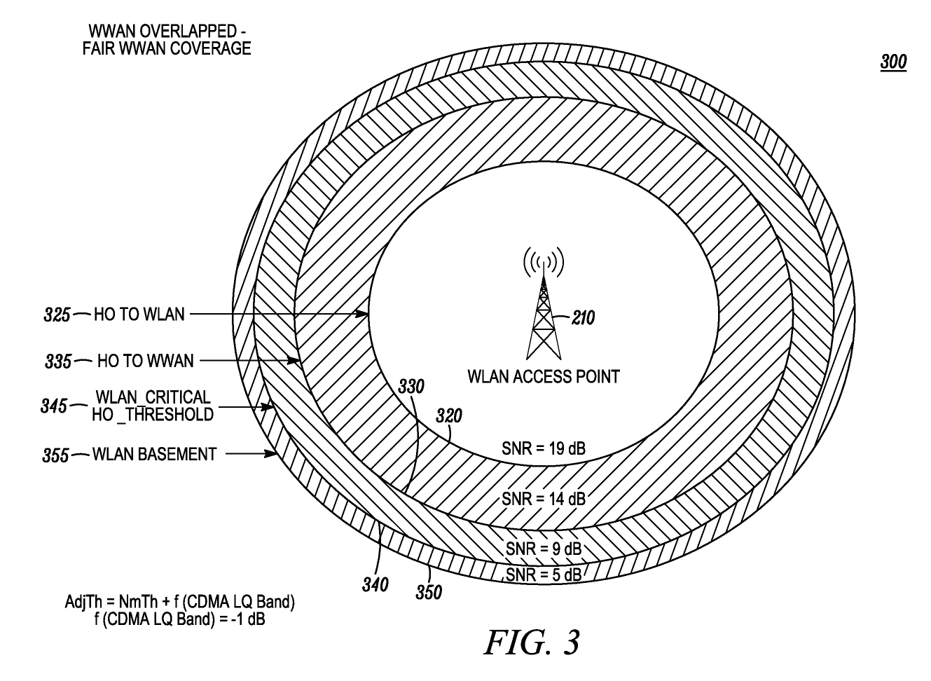

In certain scenarios, the coverage offered by the CDMA service fluctuates from good to fair, fair to poor, poor to no service, and vice versa due to various static or dynamic variables such as, CDMA loading, movement of the mobile station, and geographic features such as intervening buildings, trees, and hills. Transitioning from FIG. 2 to FIG. 3, the coverage offered by the CDMA service goes from good to fair (i.e., a measured Link Quality of the CDMA service indicates “fair” CDMA coverage). According to the Function Table 1, the LQ factor for a fair CDMA coverage is “−1 dB.” According to equation (1), an adjusted first handoff threshold value 320 and an adjusted second handoff threshold value 330 are as follows,

Adjusted first handoff threshold=20 dB−1 dB=19 dB

Adjusted second handoff threshold=15 dB−1 dB=14 dB

The LQ factor is defined in such a way that as the Link Quality of the CDMA service decreases, the LQ factor also decreases thereby decreasing the nominal handoff thresholds 325, 335. As already mentioned, decreasing the nominal handoff thresholds 325, 335 of the serving system expands the footprint of the serving system as shown in FIG. 3. Expanding the footprint of the WiFi service delays the handoff of the mobile station from WiFi to CDMA service and accelerates the handoff of the mobile station from CDMA to WiFi service.

As shown in FIG. 3, the critical handoff threshold 345 is adjusted by the LQ factor. The adjusted critical handoff threshold 340 is then used for handoff from WiFi to CDMA. For a Link Quality factor of say “−1 dB” for a “fair” LQ band, the adjusted critical handoff threshold value 340 is as follows,

Adjusted critical handoff threshold=10 dB−1 dB=9 dB

A handoff from WiFi service to CDMA service occurs later when the signal strength of WiFi service reaches the adjusted critical handoff threshold value 340 of 9 dB SNR instead of the nominal critical handoff threshold of 10 dB SNR. The WiFi basement value 350 of 5 dB SNR as shown in figure remains unaltered.

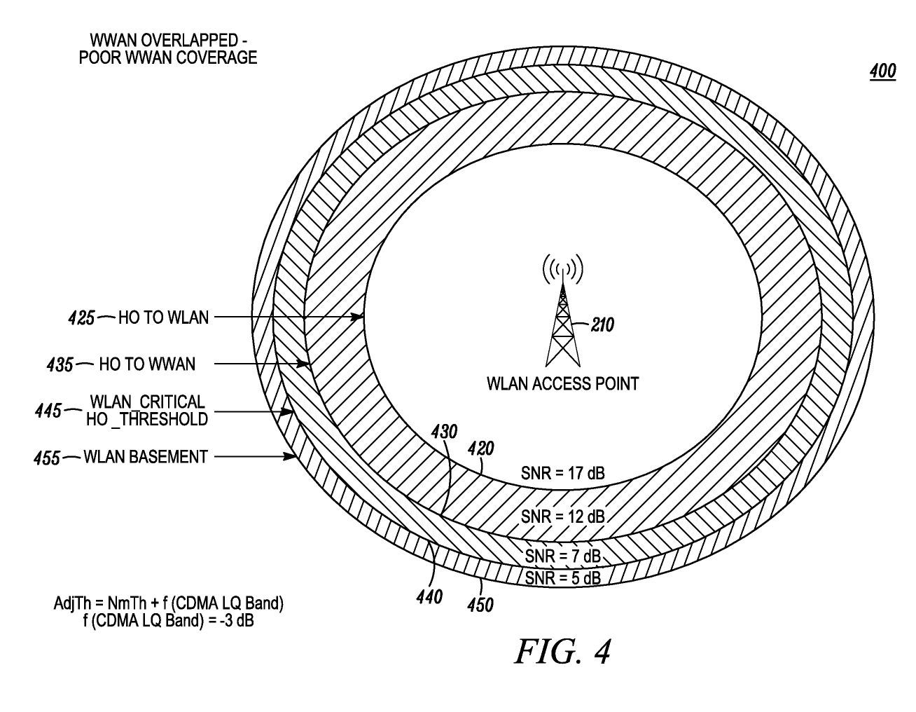

FIG. 4 illustrates a scenario when the coverage offered by the CDMA service is considered “poor” coverage. According to the Function Table, the LQ factor is “−3 dB.” The first nominal handoff threshold 425 and the second nominal handoff threshold 435 are adjusted according to equation (1). The adjusted first handoff threshold value 420 for a handover (from WWAN to WLAN) and an adjusted second handoff threshold value 430 for a handover (from WLAN to WWAN) are as follows,

Adjusted first handoff threshold=20 dB−3 dB=17 dB

Adjusted second handoff threshold=15 dB−3 dB=12 dB

Thus, the footprint of the WiFi service is further expanded as shown in FIG. 4. The handoff of the mobile station from WiFi to CDMA service is further delayed and the handoff of the mobile station from CDMA to WiFi service occurs faster.

The critical handoff threshold 445 is adjusted by the LQ factor. The adjusted critical handoff threshold 440 is then used for handoff from WiFi to CDMA. For a Link Quality factor of say “−3 dB” for a “poor” LQ band, the adjusted critical handoff threshold 440 for the critical handoff threshold 445 is as follows,

Adjusted critical handoff threshold=10 dB−3 dB=7 dB

A handoff from WiFi service to CDMA service occurs later when the signal strength of WiFi service is at the adjusted critical handoff threshold of 7 dB SNR instead of the nominal critical handoff threshold of 10 dB SNR. The WiFi basement 450 of 5 dB SNR as shown in figure remains unaltered.

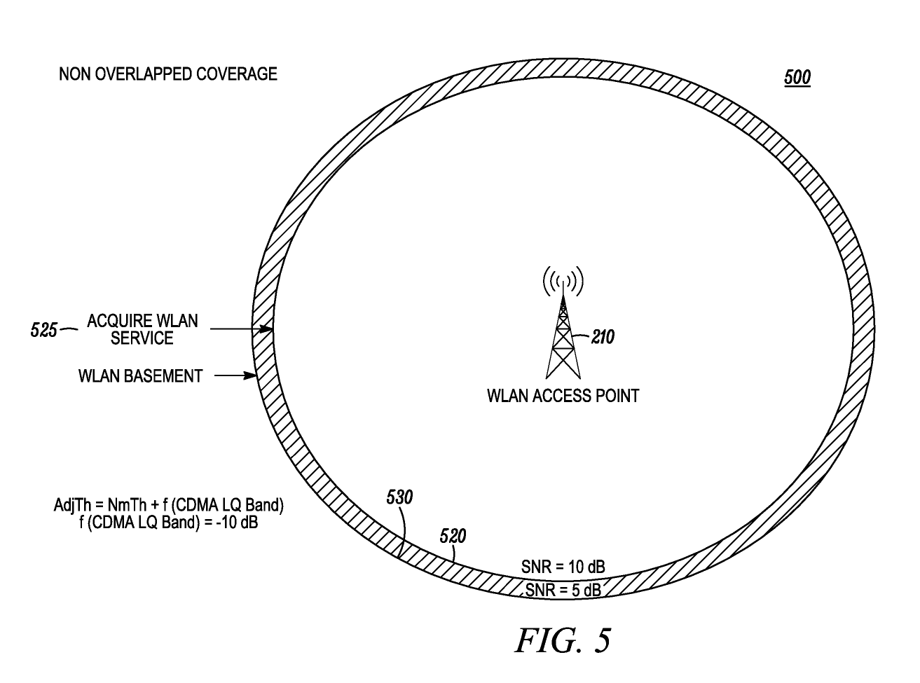

FIG. 5 illustrates a scenario where there is no CDMA coverage. As per the Function Table, the LQ factor is “−10 dB.” According to equation (1), the adjusted first and second thresholds are as follows,

Adjusted first threshold=20 dB−10 dB=10 dB

Adjusted second threshold=15 dB−10 dB=5 dB

The footprint of the WiFi service is further expanded such that when the signal strength of the WiFi service crosses the adjusted second handoff threshold value 530 of 5 dB SNR (which is shown in FIGS. 2-4 as a WiFi basement), a call handled by the mobile station gets dropped.

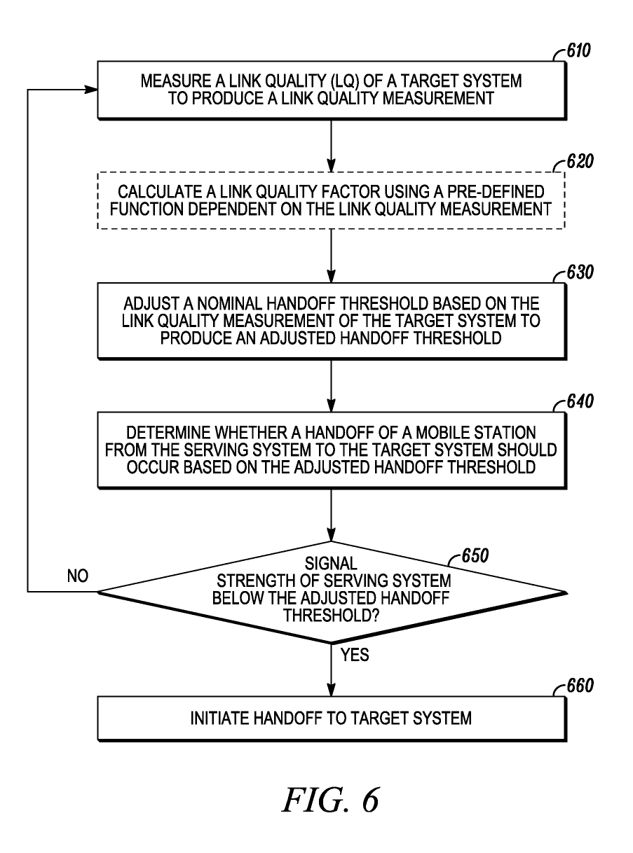

FIG. 6 is a flowchart of a method for handover of a mobile station from a serving system to a target system in accordance with some embodiments. At step 610, the mobile station measures a Link Quality of a target system to produce a Link Quality measurement. The Link Quality is measured by determining a ratio of energy per chip to interference power spectral density (Ec/Io) of the target system. In an embodiment, the mobile station categorizes the Link Quality measurements into a plurality of Link Quality bands. At step 620, the mobile station determines a Link Quality factor using a pre-defined function. The pre-defined function depends on the Link Quality band of the Link Quality measurement. Although the embodiments used here use a Function Table as the pre-defined function, the pre-defined function could also be implemented as a mathematical function or as a group of mathematical functions. At step 630, the mobile station adjusts a nominal handoff threshold based on the Link Quality measurement of the target system to produce an adjusted handoff threshold. The nominal handoff threshold is adjusted either by increasing or decreasing the nominal handoff threshold by the Link Quality factor. Decreasing the nominal handoff threshold for the serving system expands a geographic coverage area of the serving system. The mobile station decreases the nominal handoff threshold when the Link Quality measurement of the target system is below a predetermined Link Quality threshold. Conversely, increasing the nominal handoff threshold for the serving system contracts a geographic coverage area of the serving system. The mobile station increases the nominal handoff threshold when the Link Quality measurement of the target system is above a predetermined threshold.

At step 640, the mobile station determines whether a handoff from the serving system to the target system should occur based on the adjusted handoff threshold. The mobile station initiates a handoff at step 660 when the signal strength of the serving system goes below the adjusted handoff threshold at step 650. Otherwise, if the signal strength of the serving system exceeds the adjusted handoff threshold, then the method returns to step 610.

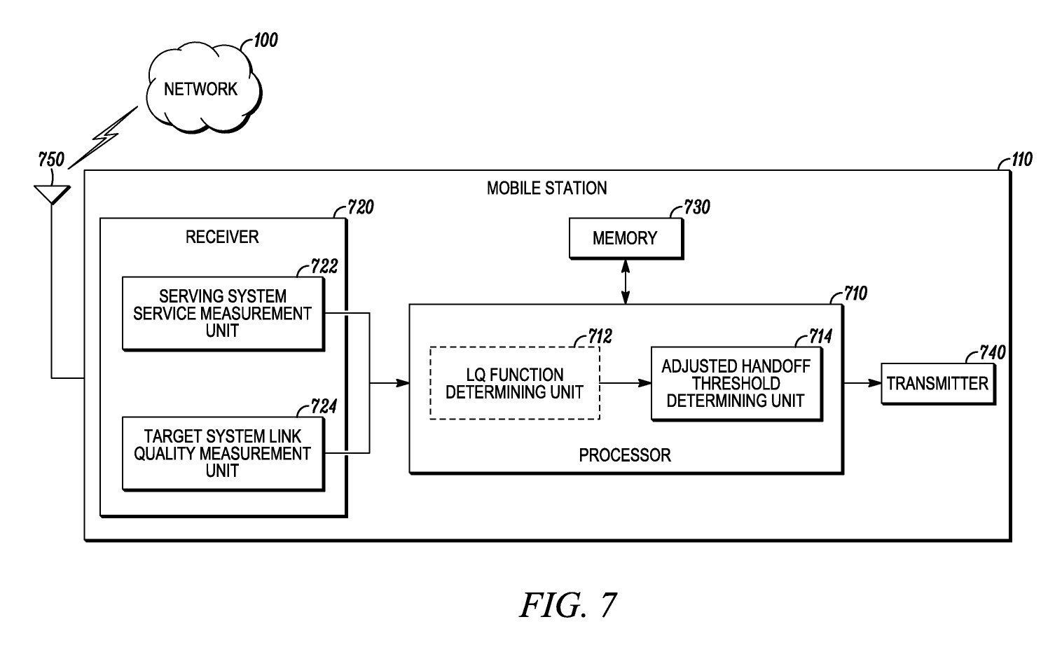

FIG. 7 is a block diagram of a mobile station 110 in accordance with some embodiments. In the embodiment, an apparatus for handover of the mobile station from a serving system to a target system is a part of the mobile station 110. The mobile station 110 communicates with a network such as the heterogeneous wireless communication system 100 of FIG. 1. The heterogeneous wireless communication system 100 includes at least two network systems e.g., 120, 130 from FIG. 1 operating using two different radio access technologies. The network providing service to the mobile station is referred as a serving system and the network capable of providing service is referred as a target system. The mobile station 110 includes a processor 710, a receiver 720 coupled to the processor 710, a memory 730, a transmitter 740, and an antenna 750. The processor 710 includes a LQ function determining unit 712 coupled to an adjusted handoff threshold determining unit 714. The receiver 720 includes a serving system service measurement unit 722 and a target system link quality measurement unit 724.

The receiver 720 receives signals from the target system via the antenna 750 and measures a Link Quality (LQ) of a target system to produce a Link Quality measurement. The Link Quality of the target system is measured as a ratio of energy per chip to interference power spectral density (Ec/Io) for a CDMA target system and measured as a Signal to Noise Ratio (SNR) or, in some systems, just Signal Strength for non-CDMA target systems. The LQ function determining unit 712 calculates a LQ factor based on a pre-defined function. The pre-defined function depends on the Link Quality measurement. The adjusted handoff threshold determining unit 714 in the processor 710 adjusts a nominal handoff threshold based on the Link Quality factor. The nominal handoff threshold is stored in the memory 730. The nominal handoff threshold is a known value, e.g., industry standard, hard-coded number etc. The serving system service measurement unit 722 in the receiver 720, periodically measures the signal strength of the serving system. The transmitter 740 coupled to the processor 710 sends a handoff command to the serving system and/or target system when the signal strength of the serving system exceeds the adjusted handoff threshold.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for handover of a mobile station from a serving system to a target system, wherein a network of the serving system uses a different Radio Access Technology than a network of the target system, the method comprising:
measuring a Link Quality (LQ) of the target system to produce a Link Quality measurement;
adjusting a nominal handoff threshold based on the Link Quality measurement of the target system to produce an adjusted handoff threshold; and
determining whether a handoff of the mobile station from the serving system to the target system should occur based on the adjusted handoff threshold.

2. The method of claim 1, wherein measuring a Link Quality of the target system comprises:
determining a ratio of energy per chip to interference power spectral density (Ec/Io) of the target system.

3. The method of claim 1, wherein adjusting a nominal handoff threshold comprises:
calculating a Link Quality factor using a pre-defined function dependent on the Link Quality measurement.

4. The method of claim 3, wherein the pre-defined function is determined based on higher granularity equations involving Link Quality measurements of the target system.

5. The method of claim 3, wherein the pre-defined function is determined based on predictive changes, wherein predictive changes are based on historical Link Quality measurements.

6. The method of claim 3 further comprising:
categorizing the Link Quality measurement into one of a plurality of Link Quality bands.

7. The method of claim 6, wherein the plurality of Link Quality bands comprise:
a good Link Quality band, when an Ec/Io measurement is greater than a first threshold; and
an unavailable service Link Quality band, when an Ec/Io measurement is less than a second threshold,
wherein the first threshold is greater than the second threshold.

8. The method of claim 7, wherein the plurality of Link Quality bands further comprise:
a fair Link Quality band, when an Ec/Io measurement is less than the first threshold and greater than a third threshold,
wherein the third threshold is greater than the second threshold.

9. The method of claim 8, wherein the plurality of Link Quality bands further comprise:
a poor Link Quality band, when an Ec/Io measurement is less than the third threshold and greater than the second threshold.

10. The method of claim 1, wherein adjusting a nominal handoff threshold comprises:
expanding a geographic coverage area of the serving system when the Link Quality measurement of the target system is below a predetermined Link Quality threshold.

11. The method of claim 10, wherein expanding a geographic coverage area of the serving system comprises:
decreasing the nominal handoff threshold for the serving system based on of the Link Quality measurement of the target system.

12. The method of claim 1, wherein adjusting a nominal handoff threshold comprises:
contracting the geographic coverage area of the serving system when the Link Quality measurement of the target system is above a predetermined Link Quality threshold.

13. The method of claim 12, wherein contracting a geographic coverage area of the serving system comprises:
increasing the nominal handoff threshold for the serving system based on the Link Quality measurement of the target system.

14. The method of claim 1, wherein adjusting a nominal handoff threshold comprises:
contracting a geographic coverage area of the target system when the Link Quality measurement of the target system is below a predetermined Link Quality threshold.

15. The method of claim 14, wherein contracting a geographic coverage area of the target system comprises:
increasing the nominal handoff threshold for the target system based on of the Link Quality measurement of the target system.

16. The method of claim 1, wherein adjusting a nominal handoff threshold comprises:
expanding the geographic coverage area of the target system when the Link Quality measurement of the target system is above a predetermined Link Quality threshold.

17. The method of claim 16, wherein expanding a geographic coverage area of the target system comprises:
decreasing the nominal handoff threshold for the target system based on the Link Quality measurement of the target system.

18. The method of claim 1, wherein determining whether a handoff of the mobile station from the serving system to the target system should occur comprises:
initiating handoff of the mobile station from the serving system to the target system when a signal strength of the serving system goes below the adjusted handoff threshold.

19. The method of claim 1, wherein the target system is a Wireless Wide Area System (WWAN).

20. The method of claim 1, wherein the serving system is a Wireless Local Area System (WLAN).

21. An apparatus for handover of a mobile station from a serving system to a target system, wherein a network of the serving system is different from a network of the target system, the apparatus comprising:
a receiver for measuring a Link Quality (LQ) of a target system to produce a Link Quality measurement; and
an adjusted handoff threshold determining unit for adjusting a nominal handoff threshold based on the Link Quality measurement of the target system to create an adjusted handoff threshold.

22. The apparatus of claim 21, further comprising:
a memory for storing the nominal handoff threshold, wherein the nominal handoff threshold is a known value.

23. The apparatus of claim 21, wherein the receiver comprises:
a serving system service measurement unit for periodically measuring signal strength of the serving system.

24. The apparatus of claim 21, further comprising:
a transmitter for sending a handoff command to the serving system and/or target system when the signal strength of the serving system exceeds the adjusted handoff threshold.
